(19) United States
(12) Patent Application Publication
(10) Pub. No.: US 2023/0340315 A1
(43) Pub. Date: Oct. 26, 2023

(54) WELLBORE DRILLING FLUID LUBRICITY ADDITIVE AND METHODS

(71) Applicant: AES Drilling Fluids, LLC, Houston, TX (US)

(72) Inventors: David Horton, Calgary (CA); Leigh James Gray, Missouri City, TX (US); Matthew Alan Offenbacher, Houston, TX (US); Richard Joseph Toomes, Houston, TX (US)

(21) Appl. No.: 18/177,045

(22) Filed: Mar. 1, 2023

Related U.S. Application Data
(60) Provisional application No. 63/333,456, filed on Apr. 21, 2022.

(51) Int. Cl. C09K 8/035; C09K 8/28

(52) U.S. Cl. CPC C09K 8/035; C09K 8/28; C09K 2208/34

(57) ABSTRACT

Ether amines, or salts thereof, are proposed for use herein as lubricity additives for drilling fluids. Methods for wellbore operations and for improving lubricity include adding an ether amine to the drilling fluid. The ether amine is represented by the general formula:

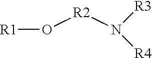

where R1 is represented by the general formula:

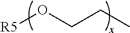

where R5 is a straight chain, branched, or cyclic aliphatic radical with about 3 to 20 carbon atoms; X is 0 to 10; R2 is a straight chain, branched, or cyclic aliphatic radical with about 3 to 20 carbon atoms; and R3 and R4 are each one of H or a straight chain, branched, or cyclic aliphatic radical.

### FIELD

The present invention relates to a wellbore drilling fluid lubricity additive and methods for increasing lubricity for oil and gas wellbore drilling fluids, also called drilling muds, by adding the additive.

### BACKGROUND

Oil and gas wellbore drilling fluids, often called muds, are fluids that are used downhole during the operations performed for the purpose of exploration or wellbore operations in subterranean formations. The term drilling fluid is often used even though the fluids may be used for other post-drilling operations such as completions.

Drilling fluids may water-based or invert emulsion, which include oil-based types and synthetic types and, regardless, contain numerous chemicals for performance.

Drilling fluids are circulated through the wellbore and perform a number of functions. One important function is to cool and lubricate the drill bit and drill string. In particular, the drilling fluid acts as lubricant between the drill bit, the drill string and the borehole walls. In general, the use of the basic water or oil of the drilling fluid is not sufficient alone to reduce friction substantially, especially if horizontal and highly deviated wells are considered. Thus, in general, a suitable lubricant additive has to be added to the drilling fluid.

While many drilling fluid lubricants are known, most lubricants have a very short life at wellbore conditions. In particular, many lubricants are just strong wetting agents. Typically, when used in oil-based drilling fluids and exposed to heat, they degrade and become dispersed into the emulsion. As such, so they do not offer sustained lubricity and fail to provide a solution in the field.

### SUMMARY

A lubricity additive, drilling fluid and methods have been invented.

In accordance with a broad aspect of the present invention, there is provided a method for increasing lubricity of a drilling fluid, comprising: i) adding an ether amine to the wellbore fluid.

In accordance with another broad aspect of the present invention, there is provided a method for conducting a wellbore operation, comprising: i) adding an ether amine to a drilling fluid; and ii) circulating the drilling fluid through a well during the wellbore operation.

In accordance with another broad aspect of the present invention, there is provided an invert emulsion drilling fluid for a wellbore operation, comprising: an oleaginous phase, an aqueous phase, an emulsifier; and an ether amine.

In accordance with another broad aspect of the present invention, there is provided a drilling fluid lubricity additive comprising: an ether amine.

In another broad aspect, an ether amine is used as a lubricity additive for drilling fluid.

It is to be understood that other aspects of the present invention will become readily apparent to those skilled in the art from the following detailed description, wherein various embodiments of the invention are shown and described by way of example. As will be realized, the invention is capable for other and different embodiments and its several details are capable of modification in various other respects, all without departing from the spirit and scope of the present invention. Accordingly, the detailed description and examples are to be regarded as illustrative in nature and not as restrictive.

### BRIEF DESCRIPTION OF THE DRAWINGS

For a better appreciation of the invention, the following Figures are appended:

FIG. 1 is a chart showing the results of Example I, reduction in coefficient of friction over baseline in samples treated with an ether amine lubricant;

FIG. 2 is a chart showing the results of Example IV before hot rolling;

FIG. 3 is a chart showing the results of Example IV after hot rolling; and

FIG. 4 is a graph showing torque reduction observed using an additive blend according to Example VI.

### DETAILED DESCRIPTION OF VARIOUS ASPECTS

The detailed description set forth below is intended as a description of the present invention and is not intended to represent the only embodiments contemplated by the inventor. The detailed description includes specific details for the purposes of providing a comprehensive understanding of the present invention. However, it will be apparent to those skilled in the art that the present invention may be practiced without these specific details.

Herein, it is shown that ether amines perform well to improve lubricity of drilling fluids. When used in drilling fluids, an ether amine additive offers sustained lubricity.

The ether amine additive is useful in all of oil-based, synthetic and water-based drilling fluids. In invert emulsion drilling fluids, both oil-based (i.e. diesel) and synthetic, the ether amine performs very well to reduce the rotary torque/coefficient of friction. The lubricity is sustained over time at typical wellbore conditions.

A basic invert emulsion drilling fluid comprises:
A base fluid including:
   An oleaginous phase—for example 30-100% by volume (v/v);
   An aqueous phase—for example 0-70% by volume (v/v);
An emulsifier—for example, 1-5% by weight of the drilling fluid (w/w); and
Other additives—for example 3-45% by weight of the drilling fluid (w/w) such as may be selected from one or more of: an alkalinity source, a weighting agent, a wetting agent, a viscosifier, a filtration control agent, a thinner/dispersant, or a lost circulation material.

The oleaginous phase can include natural or synthetic hydrocarbons including any one or more of: olefin, paraffin, ester, mineral oil, crude oil or distilled oil, including for example diesel.

The aqueous phase can include water, salt, and/or polyol, including for example, any of calcium chloride, sodium chloride, sodium bromide, glycol, glycerin and combinations thereof.

Emulsifiers can include, for example:
Fatty acid sources, such as:
   Calcium soaps of rosin acids, fatty acids, maleated fatty acids, fumarated fatty acids, succinated fatty acids, fatty amines, fatty amides; or
   Maleated, fumarated or succinated fatty acids reacted with polyamines such as diethylenetriamine (DETA), triethylenetetramine (TETA) or tetraethylenepentamine (TEPA); or
Imidazolines (dual functionality as emulsifier and wetting agent).

Some emulsifier products are offered as AES MUL™ X, ABS MUL™, ENERMUIL™ and ENERMUL II™, by the present applicant.

Viscosifiers can include for example: organophilic clay, polymer, etc. Organophilic clay is for example, the reaction product of bismethylbishydrogenated tallow ammonium chloride with sodium montmorillonite. Some clay-based viscosifiers are available as AES VIS™ III, AES VIS™ LS and AES VIS™ HT. Some viscosifying polymers are available from the present applicant as: ENERMOD™, ENERVIS™ RM, ENERMOD™ ER.

Filtration control agents can include for example: uintaite, polymer, asphalt, etc. Some are available as FLR™, FLR™ PLUS, DURATEC™, DURATEC™ ER from the present applicant.

Weighting agents may include for example calcium carbonate, barite, ilmenite, hematite, manganese tetraoxide, etc.

Typical wetting agents include, for example:
Imidazolines (dual functionality as emulsifier and wetting agent);
Oxidized fatty acids (such as for example, palmitic, oleic, linoleic, lauric acid, myristic acid, stearic acid, arachidic acid, behenic acid, erucic acid);
Oxidized rosin acids (such as for example, abietic acid or isomers, primaric acid or isomers);
C10-C18 hydrocarbylamines (such as for example, decylamine, dodecylamine, octadecylamine);
C10-C18 fatty alcohols (such as for example, cetyl alcohol, octadecyl alcohol);
C10-C18 alkylated phenols/naphthols;
Natural fatty materials (such as for example, lard, cottonseed oil, fatty acid glycerides); or
C12-C18 fatty acid amides.

Some wetting agents are offered as AES WA™ II, AES WA™ X and ENERWET™ by the present applicant.

Other additives include thinners and dispersants and/or lost circulation material such as calcium carbonate, nut shells, etc.

Simple testing may verify the compatibility of any particular additive with the drilling fluid.
Diesel—for example 40-80% by volume (v/v);
Water—for example 10-30% by volume (v/v) and containing calcium chloride—for example 1.0-2.4% by weight by weight of the drilling fluid (w/w);
Emulsifier—for example 1-4% (w/w);
Wetting agent—for example 0.5-3% (w/w);
Viscosifier—for example 0.5-2% (w/w);
Filtration control agent—for example 0-2% (w/w); and
Weighting agent—for example, 0.1-40% (w/w)

One such drilling fluid is available as AES VERT™ available from the present applicant. AES VERT drilling fluid is available in densities typically ranging from 7.8 lbm/gal to over 20 lbm/gal. A 9.7 lbm/gal AES VERT drilling fluid contains about 60% diesel oil by volume.

A synthetic based drilling fluid may have a similar composition, but with a synthetic oleaginous phase.

A useful ether amine lubricity additive is represented by the general formula:

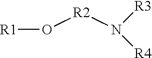

where R1 is represented by the general formula:

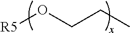

where R5 is a straight chain, branched, or cyclic aliphatic radical with about 3 to 20 carbon atoms, and X is 0 to 10:

R2 is a straight chain, branched, or cyclic aliphatic radical with about 3 to 20 carbon atoms; and

R3 and R4 are each one of H or a straight chain, branched, or cyclic aliphatic radical.

In one embodiment, the ether amine lubricity additive is a reaction product of an alcohol and an optionally substituted acrylonitrile, followed by hydrogenation.

In one embodiment, R2 is C3.

In another embodiment, the ether amine R1 is based on a coconut fatty acid such that R1 is around C30-C40.

In one embodiment, R1 is an alkyl radical having 8 to 12 carbon atoms cyclic, branched or unbranched. For example, R1 can be a C10 alkyl radical selected from decyl or isodecyl. In one embodiment, the ether amine is isodecyloxypropyl amine, also called 3-(8-methylnonoxy)propan-1-amine. This chemical is available as Tomamine™ EV PA 14, from Evonik Corporation. This chemical has handling characteristics that perform well in well site conditions.

The salt form of the ether amine can also be used if desired. For example, the salt form is according to the formula:

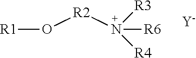

In the salt form, R1 to R4 are as defined above. R6 is H or a straight chain, branched, or cyclic aliphatic radical. Y⁻can be selected from many ion forming moieties such as any of acetate, carboxylate, halogen, nitrate, nitrite, sulfate, sulfite, borate, oxide (O—) or phosphate.

In one embodiment a suitable salt is a neutralized salt where R1 is an alkyl radical having 8 to 12 carbon atoms cyclic, branched or unbranched. For example, R1 can be C9 to C11. For example, the salt form may be based on isodecyloxypropyl amine for example, including isodecyloxypropyl amine acetate.

The ether amine lubricity additive may be employed in a liquid form.

During wellbore operations, torque limits are known for the drilling equipment and torque is monitored at least intermittently throughout the operation. Holes can be drilled with drilling fluid but without the ether amine additive until torque issues are identified. Then, the ether amine additive can be added in small increments to the drilling fluid until the torque parameters stabilize. For example, when torque limits are approached, 0.2 to 1% (volume for volume, v/v) increments of ether amine additive can be blended into the fluid and circulated while torque is monitored. When an acceptable torque condition is reached, further introduction of the additive can be discontinued or the concentration of the additive can be monitored and maintained. Alternately or in addition, if torque begins to approach the limit, then further additive can be blended in and circulated with the drilling fluid. For example, one method includes isolating a small volume of the drilling fluid and treating it with the ether amine additive, for example, at an elevated concentration higher than 1% (volume for volume, v/v). This treated volume, called a “sweep”, is circulated down the drill pipe and allowed to blend throughout the system. Multiple “sweeps” are applied as needed to reach a target concentration or when torque reduction stabilizes.

While additive pretreatment, prior to reaching a torque limit, is possible, it is generally not economically advisable.

It is useful during a drilling operation to establish a baseline and record torque before and after addition of the additive. By so doing, the operator is able to track trends and determine an optimal additive concentration for the operation.

The decision to add a lubricity additive is typically made by the drilling operator based upon well conditions. For example, in the method, the drilling fluid with the lubricity additive may be circulated during sections where significant torque is generated such as during drilling of a build section of the well bore and/or during drilling of a horizontal section of the well bore. Alternatively, or in addition, the ether amine may be added where the torque measurement is nearing an established limit for the drilling rig or the tools, where the downhole tools utilized, for example, to adjust well trajectory fail to perform properly, or where there is low rate of penetration due to suspected torque limits being reached. For example, the drilling operator may regularly or possibly continuously monitor the rig's torque condition. In some scenarios, the drilling operator may add the lubricity additive in anticipation of torque reaching 75% or possibly 90% of the rig's torque limit.

The concentration of additive added to the drilling fluid can be selected to obtain and maintain acceptable lubricity results. Generally, concentrations of greater than 0.25% (v/v), are effective to control friction in the invert emulsion drilling fluid. While amounts of up to 10% or more may be used, generally concentrations of 0.25%-6.0% (v/v) of the additive and, for example, 1.0-4.0% additive (v/v) have been found to be both effective for torque reduction and advantageous in terms of economics.

As will be appreciated, the drilling fluid may be circulated through the drill string, drill bit and well bore annulus while drilling. Circulation of the drilling fluid may continue even when drilling is stopped in order to condition the well, prevent string sticking, etc. As noted hereinbefore, drilling fluid may also be used during completion and other wellbore operations.

In one aspect, the ether amine additive is used along with other chemicals for drilling fluid performance. For example, an emulsifier may be employed along with the ether amine additive. The emulsifier may be useful to improve water retention in the drilling fluid. The emulsifier can be any one or more of the emulsifiers recited above such as one or more of (a) fatty acid sources, such as: (i) calcium soaps of rosin acids, fatty acids, maleated fatty acids, fumarated fatty acids, succinated fatty acids, fatty amines, fatty amides; or (ii) maleated, fumarated or succinated fatty acids reacted with polyamines such as diethylenetriamine (DETA), triethylenetetramine (TETA) or tetraethylenepentamine (TEPA); or (b) imidazolines. In one embodiment, the emulsifier is one or more tall oil fatty acid, including for example, maleated tall oil fatty acids or maleated tall oil fatty acid reaction products with DETA, TETA or TEPA.

While most invert emulsion drilling fluids already contain an emulsifier, the additional emulsifier added along with the ether amine maintains the stability of the drilling fluid, for example mitigates the generation of free water, without undermining lubricant performance.

In another aspect, a diluent is added to the drilling fluid along with the emulsifier and the ether amine additive. The diluent is found to reduce the pour point of the combined additive. The diluent can be one or more solvents. Some useful solvents include Group I, II and III base oils such as mineral oil, diesel or hydrotreated distillate light.

In one aspect, the ether amine additive and the emulsifier are combined together as a drilling fluid additive, herein termed a combined drilling fluid additive. In one embodiment, the combined drilling fluid additive includes the ether amine additive and the emulsifier combined in a volume to volume ratio of 40:60 to 60:40. The diluent may be included in the combined additive at 30 to 70% of the combined volume.

The combined additive may be supplied pre-blended in appropriate proportions or the additive chemicals may be supplied separately and all added during preparation or adjustment of the drilling fluid. Addition and blending in can be, for example, in the surface tanks.

The additive blend is employed in the drilling fluid at a concentration selected to obtain and maintain acceptable lubricity results. Generally, concentrations of the combined additive of greater than 1% (v/v), are effective to control friction in the oil-based drilling fluid. While amounts of up to 10% or more may be used, generally concentrations of 1%-6% (v/v) of the combined additive and, for example, 2-4% additive (v/v) have been found to be both effective for torque reduction and acceptable in terms of economics.

The method for employing the combined additive follows that described above for the ether amine alone.

The following examples are included for the purposes of illustration only, and are not intended to limit the scope of the invention or claims.

### EXAMPLES

Example I: A lubricity evaluation monitor can be employed to measure coefficient of friction in drilling fluids. The monitor operates to rotate a spindle against a block, while fluid is circulated through a cell in which the spindle is operating.

Drilling fluid samples were prepared using the 9.7 lbm/gal diesel-based fluid available as AES VERT, which contains: 62% by volume diesel; 25% by volume of 25% w/w calcium chloride brine; 6 lb/bbl organophilic clay; 6 lb/bbl emulsifier; 88 lb/bbl weighting agent; and 9 lb/bbl total combined of other components including: wetting agent, alkalinity source and filtration control additive.

Isodecyloxypropyl amine (Tomamine™ EV PA 14) was added as a lubricant to four drilling fluid samples at concentrations of 1%, 2%, 4% and 6% (v/v), respectively.

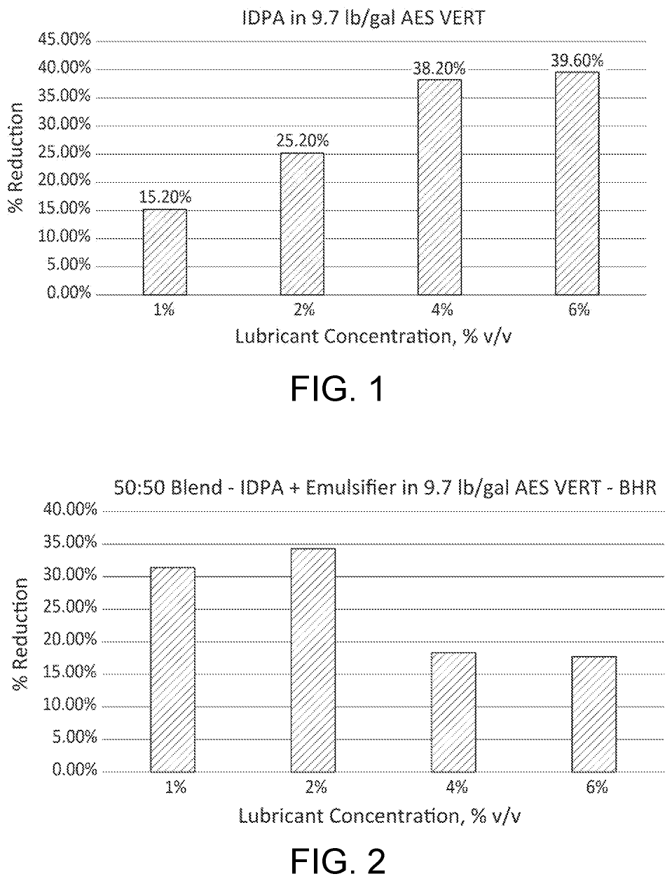

Using the lubricity evaluation monitor, a baseline coefficient of friction (CoF) was measured on an untreated drilling fluid sample. The coefficient of friction was then measured for the four treated samples. The results are shown in FIG. 1. Even the lubricant added at 1% resulted in a reduction in CoF over the untreated sample. Reductions in CoF of up to 40% were achieved at a concentration of 6% v/v as shown.

Example II: Drilling fluid samples were prepared using the 9.7 lbm/gal and the 12.7 lbm/gal diesel-based fluid AES VERT. The composition of the 12.7 lbm/gal drilling fluid is:

54% by volume diesel; 24% by volume of 25% w/w calcium chloride brine; 252 lb/bbl weighting agent; 6 lb/bbl emulsifier; 4 lb/bbl organophilic clay; and 11 lb/bbl total of wetting agent, alkalinity source and filtration control additive.

Four drilling fluid samples were prepared as follows:
An untreated sample from each drilling fluid;
A 9.7 lbm/gal drilling fluid sample with 3% (v/v) isodecyloxypropyl amine; and
A 12.7 lbm/gal drilling fluid sample with 3% (v/v) isodecyloxypropyl amine

All samples were tested for rheology, electrical stability and free water at 150° F. and a high temperature high pressure (HTHP) viscosity was obtained at 250° F.

The treated samples were tested before hot rolling (BHR) and after hot rolling (AHR) to assess compatibility and stability. The testing was conducted according to API 13-B-2 procedure. The results are shown in Table 1.

TABLE 1
Testing of isodecyloxypropyl amine (IDPA)
in 9.7 lb/gal and 12.7 lb/gal AES VERT

| | 9.7 lb/gal | | 3% v/v | | 12.7 lb/gal | | 3% v/v | |
|---|---|---|---|---|---|---|---|---|
| PROPERTIES | BASELINE | | IDPA | | BASELINE | | IDPA | |
| BHR/AHR | BHR | — | BHR | AHR | BHR | AHR | BHR | AHR |
| Hot Roll | 250° F. | | 250° F. | | 250° F. | | 250° F. | |
| Temp, ° F. | | | | | | | | |
| R₆₀₀, ° V-G | 37 | — | 34 | 34 | 51 | — | 48 | 58 |
| R₃₀₀, ° V-G | 23 | — | 21 | 20 | 31 | — | 29 | 35 |
| R₂₀₀, ° V-G | 17 | — | 16 | 15 | 23 | — | 22 | 27 |
| R₁₀₀, ° V-G | 11 | — | 11 | 9 | 15 | — | 14 | 18 |
| R₆₀, ° V-G | 9 | — | 8 | 7 | 11 | — | 11 | 14 |
| R₃₀, ° V-G | 6 | — | 6 | 5 | 8 | — | 8 | 11 |
| R₆, ° V-G | 4 | — | 4 | 3 | 5 | — | 6 | 8 |
| R₃, ° V-G | 4 | — | 3 | 3 | 5 | — | 5 | 7 |
| Plastic | 14 | — | 14 | 14 | 20 | — | 19 | 23 |
| Viscosity, cP | | | | | | | | |
| Yield Point, | 9 | — | 7 | 6 | 11 | — | 10 | 12 |
| lb/100 ft² | | | | | | | | |
| 10 sec gel, | 4 | — | 4 | 3 | 5 | — | 6 | 7 |
| lb/100 ft² | | | | | | | | |
| 10 min gel, | 5 | — | 4 | 3 | 5 | — | 6 | 7 |
| lb/100 ft² | | | | | | | | |
| Electrical | 318 | — | 331 | 300 | 480 | — | 504 | 745 |
| Stability, volts | | | | | | | | |
| HTHP, | — | — | | 20.4 | — | — | — | 8.0 |
| cc/30 min | | | | | | | | |
| Free Water, | — | — | | 6.4 | — | — | — | 0.0 |
| cc/30 min | | | | | | | | |

The rheology results were very good, even after hot rolling. The generation of free water in the treated drilling fluid samples after hot rolling was noted.

Example III: Three drilling fluid samples were prepared using the 9.7 lbm/gal and the 12.7 lbm/gal diesel-based fluid AES VERT. In some testing, an emulsifier and/or a diluent was employed with the ether amine as a blend. The diluent was hydrotreated distillate light (CAS 64742-47-8) and the emulsifier was maleated fatty acids reacted with diethylenetriamine. The samples were as follows:
A 9.7 lbm/gal drilling fluid sample with 6% (v/v) blend of 50:50 isodecyloxypropyl amine and emulsifier;
A 9.7 lbm/gal drilling fluid sample with 3% (v/v) blend of 25:25:50 isodecyloxypropyl amine : emulsifier : diluent; and
A 12.7 lbm/gal drilling fluid sample with 3% (v/v) blend of 25:25:50 isodecyloxypropyl amine : emulsifier : diluent.

As with Example II, all samples were tested before hot rolling (BHR) and after hot rolling (AHR) for rheology, electrical stability and free water at 150° F. and a high temperature high pressure (HTHP) viscosity was obtained at 250° F.

The results are shown in Table 2.

TABLE 2
Testing of combined additive blends
in 9.7 and 12.7 lb/gal AES VERT

| | 9.7 lb/gal 6% | | 9.7 lb/gal 3% v/v | | 12.7 lb/gal 3% v/v | |
|---|---|---|---|---|---|---|
| | v/v IDPA + | | IDPA + | | IDPA + | |
| | emulsifier | | emulsifier + | | emulsifier + | |
| PROPERTIES | (50:50) | | diluent (25:25:50) | | diluent (25:25:50) | |
| BHR/AHR | BHR | AHR | BHR | AHR | BHR | AHR |
| Hot Roll | 250° F. | | 250° F. | | 250° F. | |
| Temp, ° F. | | | | | | |
| R₆₀₀, ° V-G | 37 | 37 | 35 | 34 | 50 | 54 |
| R₃₀₀, ° V-G | 23 | 21 | 20 | 19 | 29 | 32 |
| R₂₀₀, ° V-G | 17 | 16 | 15 | 14 | 22 | 25 |
| R₁₀₀, ° V-G | 11 | 10 | 10 | 8 | 14 | 16 |
| R₆₀, ° V-G | 9 | 7 | 7 | 6 | 10 | 13 |
| R₃₀, ° V-G | 6 | 5 | 5 | 3 | 7 | 9 |
| R₆, ° V-G | 4 | 3 | 3 | 2 | 5 | 6 |
| R₃, ° V-G | 4 | 3 | 2 | 2 | 5 | 5 |
| Plastic | 14 | 16 | 15 | 15 | 21 | 22 |
| Viscosity, cP | | | | | | |
| Yield Point, | 9 | 5 | 5 | 4 | 8 | 10 |
| lb/100 ft² | | | | | | |
| 10 sec gel, | 4 | — | 3 | 2 | 4 | 4 |
| lb/100 ft² | | | | | | |
| 10 min gel, | 5 | — | 3 | 2 | 4 | 5 |
| lb/100 ft² | | | | | | |

The samples showed good compatibility and stability even after hot rolling.

Example IV: Drilling fluid samples were prepared using the 9.7 lbm/gal diesel-based fluid 1%, 2%, 4% and 6% (v/v), respectively, of the 50:50 isodecyloxypropyl amine and emulsifier blend from Example III.

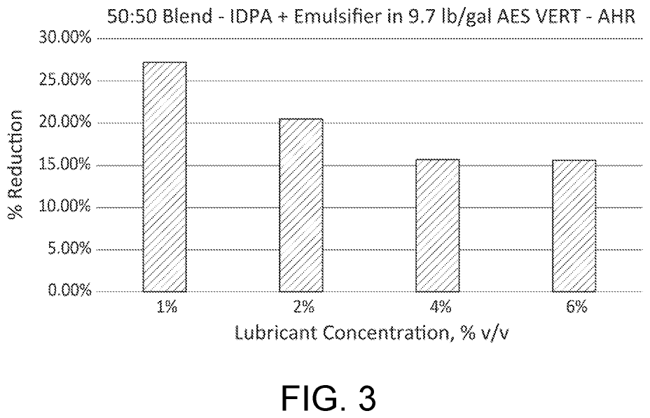

Using the lubricity evaluation monitor, a baseline coefficient of friction (CoF) was measured on an untreated drilling fluid sample. The coefficient of friction was then measured for the four treated samples before hot rolling and after hot rolling. The results are shown in FIGS. 2 and 3. A significant reduction in CoF was observed over baseline both before and after hot rolling the samples.

Example V: Drilling fluid samples were prepared using the 12.7 lbm/gal diesel-based fluid in a procedure the same as that in Example IV. A significant reduction in CoF was observed over baseline both before and after hot rolling the samples.

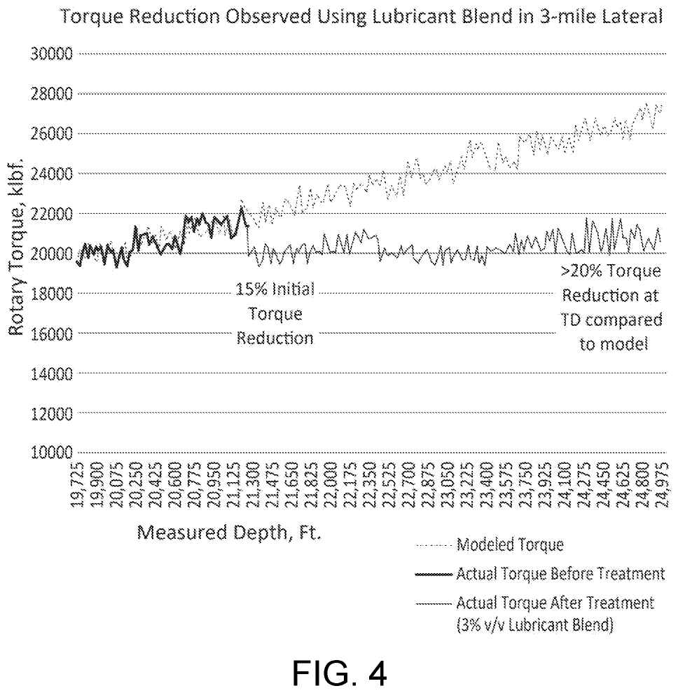

Example VI: Drilling ahead using an AES VERT drilling mud, the operator was unable to get appropriate weight on bit to maintain a target drilling rate. At about 21,125 measured depth (ft.), a 25:25:50 isodecyloxypropyl amine : emulsifier : diluent lubricant additive according to Example III was added at a concentration of 3% (v/v of drilling mud). Torque was lowered significantly even beyond what was, according to computer modelling, expected to continue drilling the well. The results are shown in FIG. 4.

Example VII: Following the procedure of Example I, four drilling fluid samples were prepared using the 9.7 lbm/gal AES VERT and ether amine lubricant additive of (coconut oil alkyl) amine (CAS # 61788-46-3), shortened to COAA, at concentrations of 1%, 2%, 4% and 6% (v/v), respectively. The lubricant system was heated to facilitate handling.

Using the lubricity evaluation monitor, a coefficient of friction (CoF) was measured for the four prepared drilling fluid samples and a baseline CoF was measured for an untreated drilling fluid sample. The results showed that the lubricant at all concentrations resulted in a reduction in CoF over the untreated sample of at least 20%.

Example VIII: Following the procedure of Example II, two drilling fluid samples were prepared using the 9.7 lbm/gal AES VERT and (coconut oil alkyl) amine (CAS # 61788-46-3) as an ether amine lubricant additive at concentrations of 1% and 3% (v/v). The lubricant system was heated to 150° F.

TABLE 3
Testing of (coconut oil alkyl) amine
in 9.7 lb/gal AES VERT at 150° F.

| | | | 1% v/v | | 3% v/v | |
|---|---|---|---|---|---|---|
| PROPERTIES | BASELINE | | COAA | | COAA | |
| BHR/AHR | BHR | — | BHR | AHR | BHR | AHR |
| Hot Roll Temp, ° F. | 250° F. | | 250° F. | | 250° F. | |
| R₆₀₀, ° V-G | 34 | — | 34 | 34 | 32 | 33 |
| R₃₀₀, ° V-G | 21 | — | 21 | 20 | 20 | 19 |
| R₂₀₀, ° V-G | 16 | — | 16 | 15 | 15 | 15 |
| R₁₀₀, ° V-G | 11 | — | 11 | 10 | 10 | 9 |
| R₆₀, ° V-G | 8 | — | 8 | 8 | 8 | 7 |
| R₃₀, ° V-G | 6 | — | 6 | 6 | 6 | 5 |
| R₆, ° V-G | 4 | — | 4 | 5 | 4 | 3 |
| R₃, ° V-G | 4 | — | 3 | 4 | 4 | 3 |
| Plastic Viscosity, cP | 13 | — | 13 | 14 | 13 | 13 |
| Yield Point, lb/100 ft² | 8 | — | 8 | 6 | 7 | 6 |
| 10 sec gel, lb/100 ft² | 4 | — | 5 | 5 | 5 | 4 |
| 10 min gel, lb/100 ft² | 6 | — | 16 | 5 | 5 | 4 |
| Electrical Stability, volts | 330 | — | 282 | 295 | 304 | 320 |
| HTHP, cc/30 min | 1.0 | — | | 9.5 | | 9.5 |
| Free Water, cc/30 min | 0.0 | — | | 2.1 | | 0.8 |

Example IX: Following the procedure of Example I, four drilling fluid samples were prepared using the 9.7 lbm/gal AES VERT and concentrations of 1%, 2%, 4% and 6% (v/v), respectively, of a blend of isodecyloxypropyl amine acetate, maleated tall fatty acids reacted with diethylenetriamine as an emulsifier and hydrotreated distillate light (CAS 64742-47-8) (ratio of 25:25:50 ether amine : emulsifier : diluent).

Using the lubricity evaluation monitor, a coefficient of friction (CoF) was measured for the four prepared drilling fluid samples and a baseline CoF was measured for an untreated drilling fluid sample. The results showed that the lubricant at all concentrations resulted in a reduction in CoF over the untreated sample of at least 15%.

The same test was conducted except the 12.7 lbm/gal AES VERT mud was employed instead of the 9.7 lbm/gal AES VERT mud. The results showed that the lubricant at all concentrations resulted in a reduction in CoF over the untreated sample of at least 20%.

Example X: Following the procedure of Example III, two drilling fluid samples were prepared using the 12.7 lb/gal AES VERT and the 9.7 lbm/gal diesel-based fluid AES VERT and each including 6% (v/v) of a blend of isodecyloxypropyl amine acetate, maleated fatty acids reacted with diethylenetriamine and hydrotreated distillate light (CAS 64742-47-8) (ratio of 25:25:50 ether amine : emulsifier : diluent). See results in Table 4.

TABLE 4
Testing of combined additive blends
in 9.7 and 12.7 lb/gal AES VERT

| | 12.7 lb/gal AES VERT | | 9.7 lb/gal AES VERT | |
|---|---|---|---|---|
| | | POST | | POST |
| | | HOT | | HOT |
| | | ROLL | | ROLL |
| | | (16 HR @ | | (16 HR @ |
| PROPERTIES | INITIAL | 250° F.) | INITIAL | 250° F.) |
| Rheology | 150 | 150 | 150 | 150 |
| Temperature, ° F. | | | | |
| R₆₀₀, ° V-G | 48 | 50 | 40 | 36 |
| R₃₀₀, ° V-G | 27 | 29 | 25 | 21 |
| R₂₀₀, ° V-G | 20 | 22 | 19 | 15 |
| R₁₀₀, ° V-G | 12 | 15 | 12 | 9 |
| R₆₀, ° V-G | 9 | 12 | 9 | 7 |
| R₃₀, ° V-G | 7 | 9 | 6 | 5 |
| R₆, ° V-G | 4 | 6 | 4 | 2 |
| R₃, ° V-G | 4 | 5 | 3 | 2 |
| Plastic Viscosity, cP | 21 | 21 | 15 | 15 |
| Yield Point, lb/100 ft² | 6 | 8 | 10 | 6 |
| 10 sec gel, lb/100 ft² | 4 | 6 | 4 | 3 |
| 10 min gel, lb/100 ft² | 6 | 7 | 5 | 3 |
| Electrical Stability, V | 498 | 568 | 315 | 285 |
| HPHT 250° F., | | 2.2/0.0 | | 1.6/0.00 |
| 2× cc/water | | | | |

The samples showed good compatibility and stability even after hot rolling.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims. No claim element is to be construed under the provisions of 35 USC 112, sixth paragraph, unless the element is expressly recited using the phrase “means for” or “step for”.

1. A method for drilling a wellbore into a formation, the method comprising:
circulating a drilling fluid through the wellbore being drilled; and,
adding an ether amine to the drilling fluid to adjust drilling fluid lubricity.

2. The method of claim 1, wherein the ether amine is represented by the general formula 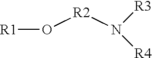
or a salt thereof, where R1 is represented by the general formula: 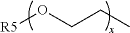
where R5 is a straight chain, branched, or cyclic aliphatic radical with about 3 to 20 carbon atoms;
where X is 0 to 10;
where R2 is a straight chain, branched, or cyclic aliphatic radical with about 3 to 20 carbon atoms; and
where R3 and R4 are each one of H or a straight chain, branched, or cyclic aliphatic radical.

3. The method of claim 2, wherein adding the ether amine is initiated when the torque limit of the rig reaches 75% and further comprising:
adding along with the ether amine: both a tall oil fatty acid as an emulsifier; and a solvent selected from Group I, II or III base oils.

4. The method of claim 1, wherein the ether amine is isodecyloxypropyl amine or a salt thereof.

5. The method of claim 1, wherein adding adds the ether amine at a concentration of at least 0.25% volume by volume of the drilling fluid.

6. The method of claim 1, wherein the ether amine is present in the drilling fluid at a concentration of 0.25% to 6.0% volume by volume of the drilling fluid.

7. The method of claim 1, further comprising adding an emulsifier in addition to adding the ether amine.

8. The method of claim 7, wherein the emulsifier is added at a ratio of 40:60 to 60:40 relative to the ether amine.

9. The method of claim 7, further comprising adding a diluent in addition to adding the ether amine and the emulsifier.

10. The method of claim 1, wherein adding an ether amine is initiated when the torque limit of the rig reaches 75%.

11. The method of claim 1, wherein adding the ether amine is commenced during drilling of a build section of the well bore.

12. The method of claim 1, wherein adding the ether amine is commenced during drilling of a horizontal section of the well bore.

13. A lubricity additive for a drilling fluid comprising:
an ether amine according to formula: 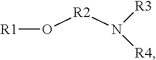
or a salt thereof, where R1 is represented by the general formula: 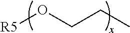
where R5 is a straight chain, branched, or cyclic aliphatic radical with about 3 to 20 carbon atoms;
where X is 0 to 10;
where R2 is a straight chain, branched, or cyclic aliphatic radical with about 3 to 20 carbon atoms; and
where R3 and R4 are each one of H or a straight chain, branched, or cyclic aliphatic radical.

14. The lubricity additive of claim 13, wherein the ether amine is isodecyloxypropyl amine or a salt thereof.

15. The lubricity additive of claim 14, further comprising: a diluent.

16. The lubricity additive of claim 13, further comprising: an emulsifier.

17. The lubricity additive of claim 16, wherein the emulsifier is present at a ratio of 40:60 to 60:40 relative to the ether amine.

18. An invert emulsion drilling fluid comprising:
a base fluid including:
an oleaginous phase;
an aqueous phase; and
an emulsifier; and
the lubricity additive according to claim 13.

19. The drilling fluid of claim 18, wherein the ether amine is at a concentration of at least 0.25% volume by volume of the drilling fluid.

20. The drilling fluid of claim 19, wherein the ether amine is present in the drilling fluid at a concentration of 1.0% to 10.0% volume by volume of the drilling fluid.
